(19) United States
(12) Patent Application Publication
(10) Pub. No.: US 2020/0265166 A1
(43) Pub. Date: Aug. 20, 2020

(54) Information Notarization Management System and Method

(71) Applicant: Jiedong Zhong, Gaozhou (CN)

(72) Inventor: Jiedong Zhong, Gaozhou (CN)

(21) Appl. No.: 16/868,510

(22) Filed: May 6, 2020

Related U.S. Application Data
(63) Continuation of application No. PCT/CN2018/123290, filed on Dec. 25, 2018.

(51) Int. Cl. G06F 21/64; H04L 9/32; G06F 40/12

(52) U.S. Cl. CPC G06F 21/645; G06F 40/12; H04L 9/3247

(57) ABSTRACT

The present disclosure provides an information notarization management system and method. The information notarization management system comprises a primary user unit, an information notarization establishment unit, an information notarization application unit, a notarization application information confirmation unit, a notarization information auditing unit, and an information notarization service unit. The information notarization management method discloses the steps about how to realize the information notarization management.

### CROSS REFERENCE TO RELATED APPLICATIONS

The present application is a Continuation Application of PCT Application No. PCT/CN2018/123290 filed on Dec. 25, 2018, the contents of which are incorporated herein by reference in their entirety.

### FIELD OF THE DISCLOSURE

The present disclosure relates generally to management system. More specifically, the present disclosure relates to Information notarization management system and method.

### DISCUSSION OF THE STATE OF THE ART

Along with the civilization and development in human society, communication, interaction, intercourse, compromise and cooperation would become more frequent and closer activities among people. To make the social communication and any transaction with restrictive, efficient and faithful manner, a non-profit third party act as a kind of authentication role on the information notarization and certification is introduced.

### SUMMARY OF THE DISCLOSURE

In one embodiment, an information notarization management system is provided. The information notarization management system comprises a primary user unit, an information notarization establishment unit, an information notarization application unit, a notarization application information confirmation unit, a notarization information auditing unit, and an information notarization service unit, wherein the information notarization establishment unit is configured to accept a request from the primary user unit to establish several notarization information units, the notarization information units are configured to serve as standards for notarization management by the information notarization management system, the information notarization application unit is configured to send invitations to several participating users for notarization according to notarization requests sent by the information notarization establishment unit, the notarization application information confirmation unit is configured to confirm whether the participating users meet notarization requirements according to the standards for notarization management sent by the information notarization application unit, and if the participating users meet the notarization requirements, the notarization information auditing unit performs notarization on the participating users to obtain notarized participating users, and the information notarization service unit provides information notarization services for the primary user unit and the notarized participating users.

In the best approach, the notarization information units comprise a certificate unit, an invitation unit, a guarantee unit, a contract unit, an agreement unit, an IOU unit, a receipt unit, a memorandum unit, a testimonial unit, a warranty unit, a production date unit, a delivery order unit, an interchange receipt unit, a mortgage bond unit, and a subpoena unit.

In the best approach, the information notarization service unit comprises an information notarization document establishment unit, an information notarization document exporting unit, an information notarization document downloading unit, an information notarization document printing unit, and an information notarization document saving unit

In the best approach, the participating users have rights to reject the invitations for notarization.

In one embodiment, an information notarization management method comprises steps of:

step S1, establishing a required information notarization module: after being started by primary users, establishing standards for information notarization management one by one;

step S2, applying for information notarization: the primary users applying for information notarization;

step S3, confirming notarization application information: inviting several participating users to perform notarization, and the participating users confirming authentication services invited by the primary users;

step S4, approving of notarization: confirming the invited participating users according to the standards for notarization management, and if notarization requirements are met, proceeding to a next step;

step S5, auditing information notarization: performing information notarization auditing; and

step S6, providing an information notarization service: providing the information notarization service for the primary users and the participating users.

In the best approach, the step S6 comprises, but is not limited to: establishing an information notarization document, exporting the information notarization document, downloading the information notarization document, printing the information notarization document, and saving the information notarization document.

### BRIEF DESCRIPTION OF THE DRAWINGS

FIG. 1 is a flowchart illustrating the best approach of the information notarization management system, in accordance with some embodiments of the present disclosure.

FIG. 2 is a flowchart illustrating the best approach of the information notarization management method, in accordance with some embodiments of the present disclosure.

### DETAILED DESCRIPTION OF THE DISCLOSURE

The following embodiments are only used to explain the solution of the disclosure more clearly, and cannot limit the protection scope of the invention.

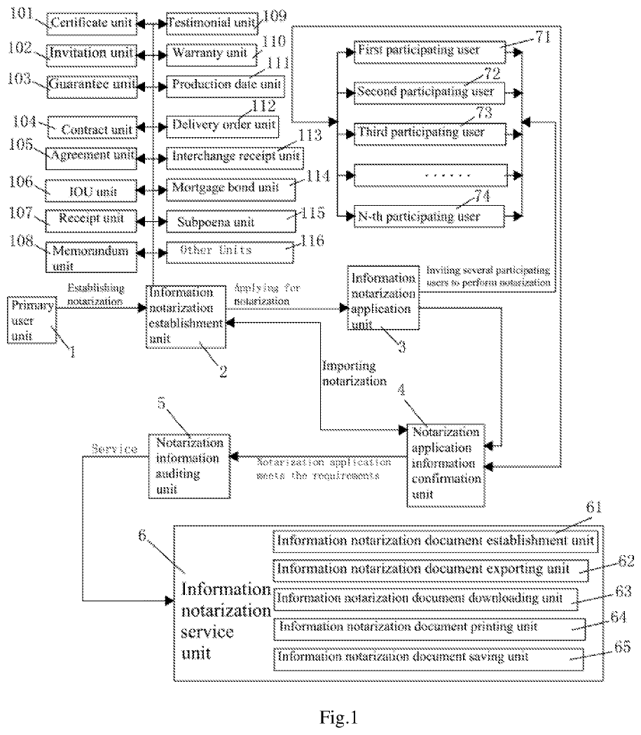

As shown in FIG. 1, the embodiments related to an information notarization management system, comprises a primary user unit 1, an information notarization establishment unit 2, an information notarization application unit 3, a notarization application information confirmation unit 4, a notarization information auditing unit 5, and an information notarization service unit 6. The information notarization establishment unit 2 is configured to accept a request from the primary user unit 1 to establish several notarization information units, and the notarization information units are configured to serve as standards for notarization management by the information notarization management system. The information notarization application unit 3 is configured to send invitations to several participating users such as the first participating user 71, the second participating user 72, the third participating user 73, . . . , the N-th participating user 74 in FIG. 1 for notarization according to notarization requests sent by the information notarization establishment unit 2. The notarization application information confirmation unit 4 is configured to confirm whether the participating users meet notarization requirements according to the standards for notarization management sent by the information notarization application unit 3. And if the participating users meet the notarization requirements, the notarization information auditing unit 5 performs notarization on the participating users to obtain notarized participating users, and the information notarization service unit 6 provides information notarization services for the primary user unit 1 and the notarized participating users.

In the best approach, the notarization information units comprise, but are not limited to: a certificate unit 101, an invitation unit 102, a guarantee unit 103, a contract unit 104, an agreement unit 105, an IOU unit 106, a receipt unit 107, a memorandum unit 108, a testimonial unit 109, a warranty unit 110, a production date unit 111, a delivery order unit 112, an interchange receipt unit 113, a mortgage bond unit 114, and a subpoena unit 115 and other units 116.

In the best approach, the information notarization service unit comprises, but is not limited to: an information notarization document establishment unit 61, an information notarization document exporting unit 62, an information notarization document downloading unit 63, an information notarization document printing unit 64, and an information notarization document saving unit 65.

In the best approach, the participating users have rights to reject the invitations for notarization.

The present disclosure can quickly introduces a third-party information notarization and authentication service with no interest relationship between the primary user and the participating users, and can provides the third-party information notarization and authentication service in real time, and the user can call his own information notarization service at any time according to the demand.

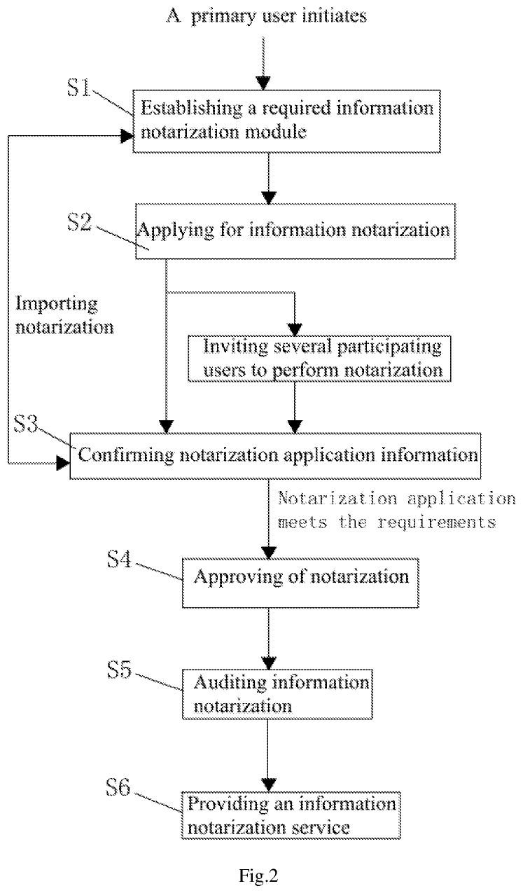

In one embodiment, an information notarization management method as shown in FIG. 2 comprises the steps as below:

step S1, establishing a required information notarization module: after being started by primary users, establishing standards for information notarization management one by one;

step S2, applying for information notarization: the primary users applying for information notarization;

step S3, confirming notarization application information: inviting several participating users to perform notarization, and the participating users confirming authentication services invited by the primary users;

step S4, approving of notarization: confirming the invited participating users according to the standards for notarization management, and if notarization requirements are met, proceeding to a next step;

step S5, auditing information notarization: performing information notarization auditing; and

step S6, providing an information notarization service: providing the information notarization service for the primary users and the participating users.

In the best approach, the step S6 comprises, but is not limited to: establishing an information notarization document, exporting the information notarization document, downloading the information notarization document, printing the information notarization document, and saving the information notarization document. This information notarization management is divided into: an information notarization establishment unit 2, an information notarization application unit 3, a notarization information auditing unit 5, and an information notarization service unit 6.

The disclosure realizes the basic principles of civil spontaneous fairness, justice, openness and equality. Civil organizations, associations and individuals could obtain the services in accordance with procedures, regulations and by spontaneously complying with laws and regulations. The system is the information notarization management system via spontaneous recognition, execution and compliance, it acts as the non-governmental and voluntary third-party information notarization system.

Although the present disclosure has been disclosed as above with reference to preferred embodiments thereof but will not be limited thereto. Those skilled in the art can modify and vary the embodiments without departing from the spirit and scope of the present disclosure. Accordingly, without departing from the scope of the present invented technology scheme, whatever simple modification and equivalent variation belong to the protection range of the present invented technology scheme.

What is claimed is:

1. An information notarization management system, comprising:
a primary user unit,
an information notarization establishment unit,
an information notarization application unit,
a notarization application information confirmation unit,
a notarization information auditing unit, and
an information notarization service unit,
wherein the information notarization establishment unit is configured to accept a request from the primary user unit to establish several notarization information units,
the notarization information units are configured to serve as standards for notarization management by the information notarization management system,
the information notarization application unit is configured to send invitations to several participating users for notarization according to notarization requests sent by the information notarization establishment unit,
the notarization application information confirmation unit is configured to confirm whether the participating users meet notarization requirements according to the standards for notarization management sent by the information notarization application unit, and
if the participating users meet the notarization requirements, the notarization information auditing unit performs notarization on the participating users to obtain notarized participating users, and the information notarization service unit provides information notarization services for the primary user unit and the notarized participating users.

2. The information notarization management system according to claim 1, wherein the notarization information units comprise a certificate unit, an invitation unit, a guarantee unit, a contract unit, an agreement unit, an IOU unit, a receipt unit, a memorandum unit, a testimonial unit, a warranty unit, a production date unit, a delivery order unit, an interchange receipt unit, a mortgage bond unit, and a subpoena unit.

3. The information notarization management system according to claim 1, wherein the information notarization service unit comprises an information notarization document establishment unit, an information notarization document exporting unit, an information notarization document downloading unit, an information notarization document printing unit, and an information notarization document saving unit

4. The information notarization management system according to claim 1, wherein the participating users have rights to reject the invitations for notarization.

5. An information notarization management method, comprising steps of:
step S1, establishing a required information notarization module: after being started by primary users, establishing standards for information notarization management one by one;
step S2, applying for information notarization: the primary users applying for information notarization;
step S3, confirming notarization application information: inviting several participating users to perform notarization, and the participating users confirming authentication services invited by the primary users;
step S4, approving of notarization: confirming the invited participating users according to the standards for notarization management, and if notarization requirements are met, proceeding to a next step;
step S5, auditing information notarization: performing information notarization auditing; and
step S6, providing an information notarization service: providing the information notarization service for the primary users and the participating users.

6. The information notarization management method according to claim 5, wherein the step S6 comprises establishing an information notarization document, exporting the information notarization document, downloading the information notarization document, printing the information notarization document, and saving the information notarization document.
